(19) United States
(12) Patent Application Publication
(10) Pub. No.: US 2013/0157677 A1
(43) Pub. Date: Jun. 20, 2013

(54) Energy-saving control method and system for wireless network

(71) Applicants: Kaimeng Liao, Shenzhen (CN); Hua Ni, Shenzhen (CN); Wei Li, Shenzhen (CN)

(72) Inventors: Kaimeng Liao, Shenzhen (CN); Hua Ni, Shenzhen (CN); Wei Li, Shenzhen (CN)

(73) Assignee: ZTE CORPORATION, Shenzhen, Guangdong (CN)

(21) Appl. No.: 13/820,405

(22) PCT Filed: Jun. 21, 2011
(86) PCT No.: PCT/CN2011/076063

§ 371 Date: Mar. 1, 2013

(30) Foreign Application Priority Data
Sep. 2, 2010 (CN) 201010272975.1

(51) Int. Cl. H04W 52/02

(52) U.S. Cl. CPC H04W 52/0206
USPC 455/452.1

(57) ABSTRACT

The disclosure provides an energy-saving control method for a wireless network, which includes: a network manager sets energy-saving control parameters and sends the parameters to a network element participating in energy-saving control; after receiving the energy-saving control parameters, the network element compares a cell performance index value of a base station controlled by the network element itself with a cell performance index threshold value contained in the energy-saving control parameters periodically, and reports a message to the network manager when the cell performance index value of the base station exceeds the cell performance index threshold value; after receiving the message, the network manager constitutes an energy-saving strategy and notifies the network element to perform energy-saving operation. The disclosure also provides an energy-saving control system for a wireless network. The method and system of the disclosure can rapidly respond to the load change of the base station, thereby effectively realizing energy-saving management of is the entire wireless network.

### TECHNICAL FIELD

The disclosure relates to an energy-saving management method in the field of communications, and in particular to an energy-saving control method and system for a wireless network.

### BACKGROUND

With the continuous development and progress of society, human have a growing demand on energy, consequently, the consumption of energy increases and energy is dried up gradually. At present, energy constraints have become an unavoidable and increasingly acute social problem. With the intensifying price competition of communication market, the reduction of operation cost becomes the key emphasis of each enterprise. In the condition of guaranteeing the quality of service, the reduction of energy consumption becomes the best option for reducing operation cost, and thus becomes a new profit growth point of operators.

From the distribution of energy consumption in the field of mobile communications, it can be seen that the energy consumption of base station accounts for 90% of the energy consumption of an entire system; the energy consumption of base station is the major part needing energy-saving control in the mobile communication network. Taking the base station in the existing most popular Global System for Mobile Communications (GSM) for example, a typical macro base station located indoors is provided with 12 carrier frequencies, and the average power consumption is 1600 W; in the existing GSM, there are about 225,000 macro base stations located indoors; taking the number of 225,000 for example, the power consumption is nearly 3.2 billion KW per year; if electric charge is 0.6 Yuan RMB/KW, then the electric charge of the base station is nearly 2 billion Yuan RMB.

Specifically, the energy consumption of base station mainly includes: energy consumption of communication equipment, energy consumption of electric distribution system, energy consumption of room environment, energy consumption of maintenance and others; for the base station located indoors, the energy consumption of communication equipment and room environment accounts for 80% of that of the base station; and the energy consumption of room environment is mainly embodied in the energy consumption of air conditioning system; if the power consumption of communication equipment is reduced, the heat amount of the communication equipment is reduced; correspondingly, the power consumption of the air conditioning system is reduced; then the power consumption of communication equipment is a major element of the energy consumption of base station. For the base station located outdoors, the power consumption of communication equipment also accounts for a big part of the energy consumption of the base station; so the reduction of the power consumption of communication equipment should be the main direction of the energy-saving control of base station.

The existing energy-saving control method generally adopts the following process: a network manager sets an energy-saving switch and parameters, and sends the parameters to a network element; after receiving the parameters, the network element performs an energy-saving analysis and executes energy-saving operation.

From the description above, it can be seen that, in the existing energy-saving control method, it is the network element that performs an energy-saving analysis and executes energy-saving operation, and the network manager only sets an energy-saving switch and parameters; however, this mode is only suitable for performing energy-saving control on the base station in a local area or the base station controlled by a single base station controller, but cannot synthesize the operation condition of the entire network to perform energy-saving management.

### SUMMARY

In view of the above, the main purpose of the disclosure is to provide an energy-saving control method and system for a wireless network, which can rapidly respond to the load change of a base station and effectively realize energy-saving management of the entire wireless network.

In order to achieve the purpose above, the technical scheme of the disclosure is realized as follows.

The disclosure provides an energy-saving control method for a wireless network, which includes: setting, by a network manager, energy-saving control parameters, and sending the parameters to a network element participating in energy-saving control;

after receiving the energy-saving control parameters, comparing, by the network element, a cell performance index value of a base station controlled by the network element itself with a cell performance index threshold value contained in the energy-saving control parameters periodically, and reporting a message to the network manager when the cell performance index value of the base station exceeds the cell performance index threshold value; and

after receiving the message, constituting, by the network manager, an energy-saving strategy and notifying the network element to perform energy-saving operation.

In the scheme above, the constituting an energy-saving strategy may include:

according to coverage and a geographic location of the base station of which the cell performance index value exceeds the cell performance index threshold value in the message, acquiring coverage, a cell performance index value and an energy-saving state of a surrounding base station of the base station; and constituting the energy-saving strategy according to the acquired information and the cell performance index value in the message.

In the scheme above, the acquiring coverage, a cell performance index value and an energy-saving state of a surrounding base station may include:

according to the coverage and the geographic location of the base station of which the cell performance index value exceeds the cell performance index threshold value in the message, finding, by the network manager, a surrounding base station of the base station of which the cell performance index value exceeds the cell performance index threshold value, and sending a message to the surrounding base station; and

after receiving the message, returning, by the surrounding base station, the information containing the coverage, the cell performance index value and the energy-saving state to the network manager.

In the scheme above, the cell performance index value of the base station exceeding the cell performance index threshold value may refer that the cell performance index value of the base station may be lower than a lower limit of the threshold value;

the constituting the energy-saving strategy according to the acquired information and the cell performance index value in the message may include:

finding, by the network manager, a base station of which coverage is overlapped with the coverage of the base station of which the cell performance index value exceeds the cell performance index threshold value, and evaluating out a base station which can provide coverage compensation in all the base stations of which the coverage is overlapped; and

according to a service type and the cell performance index value of the base station in the message, determining, in all the base stations which can provide coverage compensation, a base station which can bear service load of the base station of which the cell performance index value exceeds the cell performance index threshold value, and notifying the base station of which the cell performance index value exceeds the cell performance index threshold value to power down.

In the scheme above, the cell performance index value of the base station exceeding the cell performance index threshold value may refer that the cell performance index value of the base station is higher than an upper limit of the threshold value, and the base station of which the cell performance index value exceeds the cell performance index threshold value may be in an non-energy saving state;

the constituting the energy-saving strategy according to the acquired information and the cell performance index value in the message may include:

finding a base station of which coverage is overlapped with the coverage of the base station of which the cell performance index value exceeds the cell performance index threshold value, and judging, in all the base stations of which the coverage is overlapped, whether there is a base station in an energy-saving state; if so, notifying the base station in the energy-saving state to power on so as to share service load of the base station of which the cell performance index value exceeds the cell performance index threshold value.

In the scheme above, the cell performance index value of the base station exceeding the cell performance index threshold value may refer that the cell performance index value of the base station is higher than an upper limit of the threshold value, and the base station of which the cell performance index value exceeds the cell performance index threshold value may be in an energy-saving compensation state;

the constituting the energy-saving strategy according to the acquired information and the cell performance index value in the message may include:

finding a base station of which coverage is overlapped with the coverage of the base station of which the cell performance index value exceeds the cell performance index threshold value, and judging, in all the base stations of which the coverage is overlapped, whether there is a base station in an energy-saving state; if so, notifying the base station in the energy-saving state to power on so as to share service load of the base station of which the cell performance index value exceeds the cell performance index threshold value; and exiting, by the base station of which the cell performance index value exceeds the cell performance index threshold value, the energy-saving compensation state.

The disclosure also provides an energy-saving control system for a wireless network, which includes: a network manager and a network element;

the network manager is configured to set energy-saving control parameters and send the parameters to the network element; and to constitute an energy-saving strategy and notify the network element to perform energy-saving operation after receiving a message reported by the network element; and

the network element is configured to compare a cell performance index value of a base station controlled by the network element itself with a cell performance index threshold value contained in the energy-saving control parameters periodically after receiving the energy-saving control parameters sent from the network manager, to report the message to the network manager when the cell performance index value of the base station exceeds the cell performance index threshold value, and to perform the energy-saving operation after receiving the notification from the network manager.

In the scheme above, the network manager may further include: a setting module and an energy-saving strategy analysis module;

the setting module is configured to set energy-saving control parameters and send the parameters to the network element; and

the energy-saving strategy analysis module is configured to constitute an energy-saving strategy and notify the network element to perform energy-saving operation after receiving a message reported by the network element.

In the scheme above, the network element may further include: a comparison module, a report module and an execution module;

the comparison module is configured to compare a cell performance index value of a base station controlled by the network element itself with a cell performance index threshold value contained in the energy-saving control parameters periodically after receiving the energy-saving control parameters sent from the network manager, to send the message to the report module when the cell performance index value of the base station exceeds the cell performance index threshold value;

the report module is configured to report the message to the network manager after receiving the message sent from the comparison module; and

the execution module is configured to perform the energy-saving operation after receiving the notification from the network manager.

In the scheme above, the energy-saving strategy analysis module may be specifically configured to:

acquire coverage, a cell performance index value and an energy-saving state of a surrounding base station of the base station according to coverage and a geographic location of the base station of which the cell performance index value exceeds the cell performance index threshold value in the message, and to constitute the energy-saving strategy according to the acquired information and the cell performance index value in the message.

With the energy-saving control method and the energy-saving control system for the wireless network provided by the disclosure, the network element compares a cell performance index value of a base station controlled by the network element itself with a cell performance index threshold value contained in the energy-saving control parameters periodically and reports a message to the network manager when the cell performance index value of the base station exceeds the cell performance index threshold value; after receiving the message, the network manager constitutes an energy-saving strategy and notifies the network element to perform energy-saving operation. The method and the system of the disclosure can rapidly respond to the load change of the base station, thereby effectively realizing the energy-saving management of the entire wireless network.

In addition, after receiving the message, the network manager acquires the coverage, cell performance index value and energy-saving state of a surrounding base station of the base station according to the coverage and geographic location of the base station of which the cell performance index value exceeds the cell performance index threshold value in the message, and constitutes an energy-saving strategy according to the acquired information and the cell performance index value in the message; therefore, the energy-saving management of the entire wireless network can be realized more effectively.

### BRIEF DESCRIPTION OF THE DRAWINGS

FIG. 1 shows a flowchart of an energy-saving control method for a wireless network in the disclosure; and

FIG. 2 shows a structure diagram of an energy-saving control system for a wireless network in the disclosure.

### DETAILED DESCRIPTION

The disclosure is described below in further detail in conjunction with the drawings and specific embodiments.

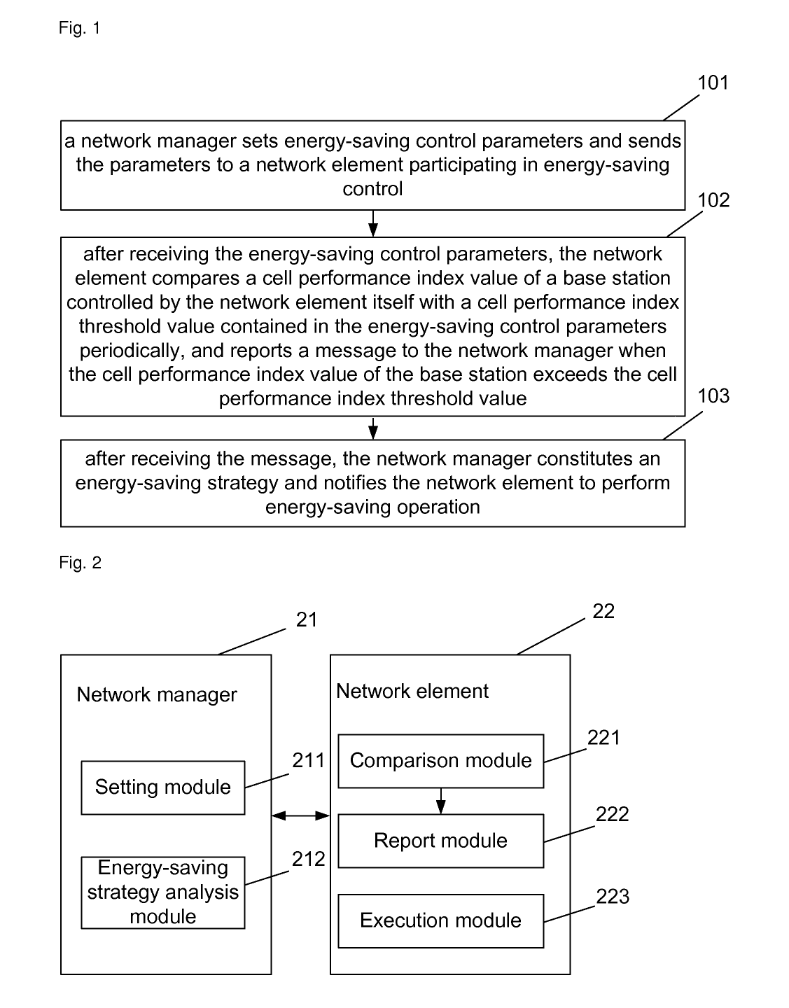

An energy-saving control method for a wireless network provided by the disclosure, as shown in FIG. 1, includes the following steps:

Step 101: a network manager sets energy-saving control parameters and sends the parameters to a network element participating in energy-saving control.

Here, the network manager can be a network element management system, or other upper-level network management systems such as a Network Management System (NMS); if the network manager is a network element management system, the network manager directly sends the parameters to the network element participating in energy-saving control; if the network manager is an upper-level network management system such as an NMS, the network manager can send the energy-saving control parameters to the network element participating in energy-saving control through a northbound interface. The energy-saving control parameters include an energy-saving switch, a cell performance index threshold value, a detection period and the like.

The network manager can send the set energy-saving control parameters to all the network elements participating in energy-saving control.

The network element participating in energy-saving control can be selected according to user's requirements, wherein the network element may be all or part of network elements managed by the network manager.

When the cell performance index threshold value is set, a cell performance index threshold value defined by the system can be adopted, or the cell performance index threshold value can be defined according to requirements. The cell performance index of the network element is selected according to the type of services born by the network element itself; for example, if the mode of a certain network element is a GSM network, then cell traffic, uplink and downlink General Packet Radio Service (GPRS) throughput and the like can be selected as the cell performance index; if the mode of a certain network element is a 3^{rd}-Generation (3G) network, then circuit domain traffic, packet domain traffic, packet domain throughput and the like can be selected as the cell performance index; if the mode of a certain network element is a Long Term Evolution (LTE) network, then uplink and downlink throughput of a cell and the like can be selected as the cell performance index.

In actual application, the cell performance index threshold value can be set of a plurality of layers; and the threshold value corresponding to each layer is set according to requirements, so that energy-saving control can be better implemented. For example, four layers such as full load, high load, low load and zero load can be set, then a threshold value corresponding to each layer is set according to requirements.

The network element detects a cell performance index value periodically according to the detection period in the energy-saving control parameters, that is, the network element detects the cell performance index value once every other a preset detection period; when being set, the detection period can be set according to requirements, for example, 3 min, 5 min and so on, so as to improve the frequency of detecting the load of network element, thereby rapidly responding to the load change and immediately providing an energy-saving measure. The detection period can be set according to network elements of different service types and the cell performance index so as to enhance the flexibility of detection.

The network element refers to a network element which can control power-on or power-off of the base station, specifically, if the mode of the network element is a GSM network or 3G network element, then the network element is a base station controller; if the mode of the network element is an LTE network, then the network element is an evolved NodeB (eNB).

Step 102: after receiving the energy-saving control parameters, the network element compares a cell performance index value of a base station controlled by the network element itself with a cell performance index threshold value contained in the energy-saving control parameters periodically, and reports a message to the network manager when the cell performance index value of the base station exceeds the cell performance index threshold value.

Here, after receiving the energy-saving control parameters, the network element can share the service load of other base stations only after turning on the energy-saving control switch in the energy-saving control parameters.

The periodic comparison refers to: comparing periodically according to the detection period in the energy-saving control parameters.

The cell performance index value of the base station exceeding the cell performance index threshold value refers that the cell performance index value of the base station exceeds the preset cell performance index threshold value upwards or downwards; for example, if an upper limit and a lower limit are set for the threshold value, when the cell performance index value of the base station is higher than the upper limit of the threshold value, a message is reported to the network manager; when the cell performance index value of the base station is lower than the lower limit of the threshold value, a message is reported to the network manager too; in this way, energy can be utilized reasonably and energy-saving control can be better implemented.

The message can be of Quality of Service (QoS) alarm, notification and other types; the message includes: coverage, a cell performance index value and a current state of the base station of which the cell performance index value exceeds the cell performance index threshold value.

The state can be a non-energy saving state, or an energy-saving state, or an energy-saving compensation state; in which the non-energy saving state refers that the base station is in a normal state, the energy-saving state refers that the base station is powered off to save energy, and the energy-saving compensation state refers that the base station is supplying coverage compensation to other base stations, that is, sharing the service load of other base stations.

Step 103: after receiving the message, the network manager constitutes an energy-saving strategy and notifies the network element to perform energy-saving operation.

Here, the network manager constituting an energy-saving strategy after receiving the message specifically includes: after receiving the message, the network manager acquires coverage, a cell performance index value and an energy-saving state of a surrounding base station of the base station according to coverage and a geographic location of the base station of which the cell performance index value exceeds the cell performance index threshold value in the message, and constitutes the energy-saving strategy according to the acquired information and the cell performance index value in the message.

The network manager configures the geographic location of each base station in advance; and the geographic location can be the longitude and latitude of the location in which the base station is.

The acquiring coverage, a cell performance index value and an energy-saving state of a surrounding base station specifically includes:

according to the coverage and the geographic location of the base station of which the cell performance index value exceeds the cell performance index threshold value in the message, the network manager finds a surrounding base station of the base station of which the cell performance index value exceeds the cell performance index threshold value, and sends a message to the surrounding base station; and

after receiving the message, the surrounding base station returns the information containing the coverage, the cell performance index value and the current state of the surrounding base station itself to the network manager.

The surrounding base station refers to a base station surrounding the base station of which the cell performance index value exceeds the cell performance index threshold value.

When the cell performance index value of the base station is lower than a lower limit of the threshold value, the constituting the energy-saving strategy according to the acquired information and the cell performance index value in the message specifically includes:

the network manager finds a base station of which coverage is overlapped with the coverage of the base station of which the cell performance index value exceeds the cell performance index threshold value, and evaluates out a base station which can provide coverage compensation in all the base stations of which the coverage is overlapped; and

according to a service type and the cell performance index value of the base station in the message, the network manager determines, in all the base stations which can provide coverage compensation, a base station which can bear service load of the base station of which the cell performance index value exceeds the cell performance index threshold value, and notifies the base station of which the cell performance index value exceeds the cell performance index threshold value to power down.

Coverage being overlapped contains two conditions as follows.

First: the coverage of the base station of which the cell performance index value exceeds the cell performance index threshold value is partially overlapped with the coverage of other base stations; or, the base station of which the cell performance index value exceeds the cell performance index threshold value is not covered by other base stations, however, through the relative location between base stations and the coverage capability, it can be considered that the coverage of the base station of which the cell performance index value exceeds the cell performance index threshold value is overlapped with the coverage of other base stations.

Second: the base station of which the cell performance index value exceeds the cell performance index threshold value is located in the coverage of other base stations.

When the base station which can bear the service load of the base station of which the cell performance index value exceeds the cell performance index threshold value is determined out, after the network manager calculates which base station bears the service load of the base station of which the cell performance index value exceeds the cell performance index threshold value according to an algorithm of the network manager itself, the entire system can be in the most energy-efficient state under the premise of guaranteeing the quality of service, hereby determining the base station which can bear the service load of the base station of which the cell performance index value exceeds the cell performance index threshold value.

In the condition that the cell performance index value of the base station is lower than the lower limit of the threshold value, for example, for a Femto base station in the coverage of a macro base station, the service load of the Femto base station is very low after 12:00 in the evening; therefore, the Femto base station can be powered off and the macro base station is used to provide coverage; in the condition that a base station of GSM/Universal Mobile Telecommunications System (UMTS) and a base station of LTE are overlapped, the base station of LTE can be powered off if the high speed data service or stream media service traffic is very low, and the base station of GSM/UMTS can be used to provide compensation coverage so as to provide voice services and low-speed data services.

When the cell performance index value of the base station is higher than the upper limit of the threshold value, it is indicated that the service load of the base station of which the cell performance index value exceeds the cell performance index threshold value exceeds a limit value, it is needed to power on a base station in an energy-saving state to share the service load; at this time, the energy-saving strategy is constituted according to the energy-saving state of the base station of which the cell performance index value exceeds the cell performance index threshold value. Specifically, when the base station of which the cell performance index value exceeds the cell performance index threshold value is in a non-energy saving state, the constituting the energy-saving strategy according to the acquired information and the cell performance index value in the message specifically includes:

finding a base station of which coverage is overlapped with the coverage of the base station of which the cell performance index value exceeds the cell performance index threshold value, and judging, in all the base stations of which the coverage is overlapped, whether there is a base station in an energy-saving state; if so, notifying the base station in the energy-saving state to power on so as to share service load of the base station of which the cell performance index value exceeds the cell performance index threshold value. If there is no base station in the energy-saving state, this condition cannot be processed; since this condition cannot embody energy-saving control, it is not contained in the disclosure.

When the base station of which the cell performance index value exceeds the cell performance index threshold value is in an energy-saving compensation state, the constituting the energy-saving strategy according to the acquired information and the cell performance index value in the message specifically includes:

finding a base station of which coverage is overlapped with the coverage of the base station of which the cell performance index value exceeds the cell performance index threshold value, and judging, in all the base stations of which the coverage is overlapped, whether there is a base station in an energy-saving state; if so, notifying the base station in the energy-saving state to power on so as to share service load of the base station of which the cell performance index value exceeds the cell performance index threshold value; and the base station of which the cell performance index value exceeds the cell performance index threshold value exiting the energy-saving compensation state. If there is no base station in the energy-saving state, this condition cannot be processed; since this condition cannot embody energy-saving control, it is not contained in the disclosure.

For example, when traffic enters a BUSY mode from an IDLE mode, the network element can wake up a base station in an energy-saving state to share the service load.

### Embodiment 1

The application scene of this embodiment is as follows: the network element supported mode is GSM; the service is a voice service and a low-speed data service.

When setting energy-saving control parameters containing an energy-saving switch, a cell performance index threshold value and a detection period, a network manager selects traffic, uplink and downlink GPRS throughput of a cell as the cell performance index, and sets corresponding threshold values; then the network manager sends the set energy-saving control parameters to a Base Station Controller (BSC); after receiving the energy-saving control parameters, the BSC compares a cell performance index value of the base station with the cell performance index threshold value in the energy-saving control parameters periodically;

when the cell performance index value of the base station is lower than a lower limit of the cell performance index threshold value, the BSC reports a message to the network manager; after receiving the message, the network manager constitutes an energy-saving strategy, that is, analyzing whether the base station needs to power down; after determining that the base station needs to power down, the network manager notifies the BSC, which then powers off the base station; when the cell performance index value of the base station is higher than an upper limit of the cell performance index threshold value, the BSC reports a message to the network manager; after receiving the message, the network manager constitutes an energy-saving strategy, that is, analyzing whether the base station needs a base station which is in an energy-saving state to power on; after determining that the base station needs a base station which is in an energy-saving state to power on, the network manager notifies the BSC, which then powers on the base station which is in the energy-saving state to share the service load.

### Embodiment 2

The application scene of this embodiment is as follows: the network element supported mode is 3G; the service is a voice service and a high-speed data service.

When setting energy-saving control parameters containing an energy-saving switch, a cell performance index threshold value and a detection period, a network manager selects circuit domain traffic, packet domain traffic and packet domain throughput as the cell performance index, and sets corresponding threshold values; then the network manager sends the set energy-saving control parameters to a Radio Network Controller (RNC); after receiving the energy-saving control parameters, the RNC compares a cell performance index value of the base station with the cell performance index threshold value in the energy-saving control parameters periodically;

when the cell performance index value of the base station is lower than a lower limit of the cell performance index threshold value, the RNC reports a message to the network manager; after receiving the message, the network manager constitutes an energy-saving strategy, that is, analyzing whether the base station needs to power down; after determining that the base station needs to power down, the network manager notifies the RNC, which then powers off the base station; when the cell performance index value of the base station is higher than an upper limit of the cell performance index threshold value, the RNC reports a message to the network manager; after receiving the message, the network manager constitutes an energy-saving strategy, that is, analyzing whether the base station needs a base station which is in an energy-saving state to power on; after determining that the base station needs a base station which is in an energy-saving state to power on, the network manager notifies the RNC, which then powers on the base station which is in the energy-saving state to share the service load.

### Embodiment 3

The application scene of this embodiment is as follows: the network element supported mode is LTE; the service is a Voice over Internet Protocol (VOIP) service and a stream media service.

When setting energy-saving control parameters containing an energy-saving switch, a cell performance index threshold value and a detection period, a network manager selects uplink and downlink throughput of a cell as the cell performance index, and sets corresponding threshold values; then the network manager sends the set energy-saving control parameters to an eNB; after receiving the energy-saving control parameters, the eNB compares a cell performance index value of the base station with the cell performance index threshold value in the energy-saving control parameters periodically;

when the cell performance index value of the base station is lower than a lower limit of the cell performance index threshold value, the eNB reports a message to the network manager; after receiving the message, the network manager constitutes an energy-saving strategy, that is, analyzing whether the base station needs to power down; after determining that the base station needs to power down, the network manager notifies the eNB to power off the base station; when the cell performance index value of the base station is higher than an upper limit of the cell performance index threshold value, the eNB reports a message to the network manager; after receiving the message, the network manager constitutes an energy-saving strategy, that is, analyzing whether the base station needs a base station which is in an energy-saving state to power on; after determining that the base station needs a base station which is in an energy-saving state to power on, the network manager notifies the eNB to power on the base station so as to share the service load.

In order to implement the method above, the disclosure also provides an energy-saving control system for a wireless network; as shown in FIG. 2, the system includes: a network manager 21 and a network element 22;

the network manager 21 is configured to set energy-saving control parameters and send the parameters to the network element 22; and to constitute an energy-saving strategy and notify the network element 22 to perform energy-saving operation after receiving a message reported by the network element 22; and

the network element 22 is configured to compare a cell performance index value of a base station controlled by the network element itself with a cell performance index threshold value contained in the energy-saving control parameters periodically after receiving the energy-saving control parameters sent from the network manager 21, to report the message to the network manager 21 when the cell performance index value of the base station exceeds the cell performance index threshold value, and to perform the energy-saving operation after receiving the notification from the network manager 21.

Here, it should be noted that the network element can be more than one network element, and the network element refers to a network element which can control the power-on or power-off of the base station.

The network manager 21 may further include: a setting module 211 and an energy-saving strategy analysis module 212;

the setting module 211 is configured to set energy-saving control parameters and send the parameters to the network element 22; and

the energy-saving strategy analysis module 212 is configured to constitute an energy-saving strategy and notify the network element 22 to perform energy-saving operation after receiving a message reported by the network element 22.

The network element 22 may further include: a comparison module 221, a report module 222 and an execution module 223;

the comparison module 221 is configured to compare a cell performance index value of a base station controlled by the network element 22 itself with a cell performance index threshold value contained in the energy-saving control parameters periodically after receiving the energy-saving control parameters sent from the network manager 21, to send the message to the report module 222 when the cell performance index value of the base station exceeds the cell performance index threshold value;

the report module 222 is configured to report the message to the network manager 21 after receiving the message sent from the comparison module 221; and

the execution module 223 is configured to perform the energy-saving operation after receiving the notification from the network manager 21.

The energy-saving strategy analysis module 212 is specifically configured to acquire coverage, a cell performance index value and an energy-saving state of a surrounding base station of the base station according to coverage and a geographic location of the base station of which the cell performance index value exceeds the cell performance index threshold value in the message, and to constitute the energy-saving strategy according to the acquired information and the cell performance index value in the message.

Here, the specific process of the energy-saving strategy analysis module in the system of the disclosure has been described in the above content, and no further description is needed here.

The above are only the preferred embodiments of the disclosure and are not intended to limit the scope of protection of the disclosure. Any modification, equivalent substitute and improvement made within the spirit and principle of the disclosure are deemed to be included within the scope of protection of the disclosure.

What is claimed is:

1. An energy-saving control method for a wireless network, comprising:
setting, by a network manager, energy-saving control parameters, and sending the parameters to a network element participating in energy-saving control;
after receiving the energy-saving control parameters, comparing, by the network element, a cell performance index value of a base station controlled by the network element itself with a cell performance index threshold value contained in the energy-saving control parameters periodically, and reporting a message to the network manager when the cell performance index value of the base station exceeds the cell performance index threshold value; and
after receiving the message, constituting, by the network manager, an energy-saving strategy and notifying the network element to perform energy-saving operation.

2. The method according to claim 1, wherein the constituting an energy-saving strategy comprises:
according to coverage and a geographic location of the base station of which the cell performance index value exceeds the cell performance index threshold value in the message, acquiring coverage, a cell performance index value and an energy-saving state of a surrounding base station of the base station; and constituting the energy-saving strategy according to the acquired information and the cell performance index value in the message.

3. The method according to claim 2, wherein the acquiring coverage, a cell performance index value and an energy-saving state of a surrounding base station comprises:
according to the coverage and the geographic location of the base station of which the cell performance index value exceeds the cell performance index threshold value in the message, finding, by the network manager, a surrounding base station of the base station of which the cell performance index value exceeds the cell performance index threshold value, and sending a message to the surrounding base station; and
after receiving the message, returning, by the surrounding base station, the information containing the coverage, the cell performance index value and the energy-saving state to the network manager.

4. The method according to claim 2, wherein the cell performance index value of the base station exceeding the cell performance index threshold value refers that the cell performance index value of the base station is lower than a lower limit of the threshold value;
the constituting the energy-saving strategy according to the acquired information and the cell performance index value in the message comprises:
finding, by the network manager, a base station of which coverage is overlapped with the coverage of the base station of which the cell performance index value exceeds the cell performance index threshold value, and evaluating out a base station which can provide coverage compensation in all the base stations of which the coverage is overlapped; and
according to a service type and the cell performance index value of the base station in the message, determining, in all the base stations which can provide coverage compensation, a base station which can bear service load of the base station of which the cell performance index value exceeds the cell performance index threshold value, and notifying the base station of which the cell performance index value exceeds the cell performance index threshold value to power down.

5. The method according to claim 2, wherein the cell performance index value of the base station exceeding the cell performance index threshold value refers that the cell performance index value of the base station is higher than an upper limit of the threshold value, and the base station of which the cell performance index value exceeds the cell performance index threshold value is in an non-energy saving state;
the constituting the energy-saving strategy according to the acquired information and the cell performance index value in the message comprises:
finding a base station of which coverage is overlapped with the coverage of the base station of which the cell performance index value exceeds the cell performance index threshold value, and judging, in all the base stations of which the coverage is overlapped, whether there is a base station in an energy-saving state; if so, notifying the base station in the energy-saving state to power on so as to share service load of the base station of which the cell performance index value exceeds the cell performance index threshold value.

6. The method according to claim 2, wherein the cell performance index value of the base station exceeding the cell performance index threshold value refers that the cell performance index value of the base station is higher than an upper limit of the threshold value, and the base station of which the cell performance index value exceeds the cell performance index threshold value is in an energy-saving compensation state;
the constituting the energy-saving strategy according to the acquired information and the cell performance index value in the message comprises:
finding a base station of which coverage is overlapped with the coverage of the base station of which the cell performance index value exceeds the cell performance index threshold value, and judging, in all the base stations of which the coverage is overlapped, whether there is a base station in an energy-saving state; if so, notifying the base station in the energy-saving state to power on so as to share service load of the base station of which the cell performance index value exceeds the cell performance index threshold value; and exiting, by the base station of which the cell performance index value exceeds the cell performance index threshold value, the energy-saving compensation state.

7. An energy-saving control system for a wireless network, comprising: a network manager and a network element;
the network manager is configured to set energy-saving control parameters and send the parameters to the network element; and to constitute an energy-saving strategy and notify the network element to perform energy-saving operation after receiving a message reported by the network element; and
the network element is configured to compare a cell performance index value of a base station controlled by the network element itself with a cell performance index threshold value contained in the energy-saving control parameters periodically after receiving the energy-saving control parameters sent from the network manager, to report the message to the network manager when the cell performance index value of the base station exceeds the cell performance index threshold value, and to perform the energy-saving operation after receiving the notification from the network manager.

8. The system according to claim 7, wherein the network manager further comprises: a setting module and an energy-saving strategy analysis module;
the setting module is configured to set energy-saving control parameters and send the parameters to the network element; and
the energy-saving strategy analysis module is configured to constitute an energy-saving strategy and notify the network element to perform energy-saving operation after receiving a message reported by the network element.

9. The system according to claim 7, wherein the network element further comprises: a comparison module, a report module and an execution module;
the comparison module is configured to compare a cell performance index value of a base station controlled by the network element itself with a cell performance index threshold value contained in the energy-saving control parameters periodically after receiving the energy-saving control parameters sent from the network manager, to send the message to the report module when the cell performance index value of the base station exceeds the cell performance index threshold value;
the report module is configured to report the message to the network manager after receiving the message sent from the comparison module; and
the execution module is configured to perform the energy-saving operation after receiving the notification from the network manager.

10. The system according to claim 9, wherein the energy-saving strategy analysis module is specifically configured to:
acquire coverage, a cell performance index value and an energy-saving state of a surrounding base station of the base station according to coverage and a geographic location of the base station of which the cell performance index value exceeds the cell performance index threshold value in the message, and to constitute the energy-saving strategy according to the acquired information and the cell performance index value in the message.

11. The method according to claim 3, wherein the cell performance index value of the base station exceeding the cell performance index threshold value refers that the cell performance index value of the base station is lower than a lower limit of the threshold value;
the constituting the energy-saving strategy according to the acquired information and the cell performance index value in the message comprises:
finding, by the network manager, a base station of which coverage is overlapped with the coverage of the base station of which the cell performance index value exceeds the cell performance index threshold value, and evaluating out a base station which can provide coverage compensation in all the base stations of which the coverage is overlapped; and
according to a service type and the cell performance index value of the base station in the message, determining, in all the base stations which can provide coverage compensation, a base station which can bear service load of the base station of which the cell performance index value exceeds the cell performance index threshold value, and notifying the base station of which the cell performance index value exceeds the cell performance index threshold value to power down.

12. The method according to claim 3, wherein the cell performance index value of the base station exceeding the cell performance index threshold value refers that the cell performance index value of the base station is higher than an upper limit of the threshold value, and the base station of which the cell performance index value exceeds the cell performance index threshold value is in an non-energy saving state;
the constituting the energy-saving strategy according to the acquired information and the cell performance index value in the message comprises:
finding a base station of which coverage is overlapped with the coverage of the base station of which the cell performance index value exceeds the cell performance index threshold value, and judging, in all the base stations of which the coverage is overlapped, whether there is a base station in an energy-saving state; if so, notifying the base station in the energy-saving state to power on so as to share service load of the base station of which the cell performance index value exceeds the cell performance index threshold value.

13. The method according to claim 3, wherein the cell performance index value of the base station exceeding the cell performance index threshold value refers that the cell performance index value of the base station is higher than an upper limit of the threshold value, and the base station of which the cell performance index value exceeds the cell performance index threshold value is in an energy-saving compensation state;
the constituting the energy-saving strategy according to the acquired information and the cell performance index value in the message comprises:
finding a base station of which coverage is overlapped with the coverage of the base station of which the cell performance index value exceeds the cell performance index threshold value, and judging, in all the base stations of which the coverage is overlapped, whether there is a base station in an energy-saving state; if so, notifying the base station in the energy-saving state to power on so as to share service load of the base station of which the cell performance index value exceeds the cell performance index threshold value; and exiting, by the base station of which the cell performance index value exceeds the cell performance index threshold value, the energy-saving compensation state.

14. The system according to claim 8, wherein the network element further comprises: a comparison module, a report module and an execution module;
the comparison module is configured to compare a cell performance index value of a base station controlled by the network element itself with a cell performance index threshold value contained in the energy-saving control parameters periodically after receiving the energy-saving control parameters sent from the network manager, to send the message to the report module when the cell performance index value of the base station exceeds the cell performance index threshold value;
the report module is configured to report the message to the network manager after receiving the message sent from the comparison module; and
the execution module is configured to perform the energy-saving operation after receiving the notification from the network manager.

15. The system according to claim 14, wherein the energy-saving strategy analysis module is specifically configured to:
acquire coverage, a cell performance index value and an energy-saving state of a surrounding base station of the base station according to coverage and a geographic location of the base station of which the cell performance index value exceeds the cell performance index threshold value in the message, and to constitute the energy-saving strategy according to the acquired information and the cell performance index value in the message.
